(19) United States
(12) Patent Application Publication
(10) Pub. No.: US 2024/0214076 A1
(43) Pub. Date: Jun. 27, 2024

(54) OPTICAL TRANSMITTER, OPTICAL TRANSMITTER ARRAY, OPTICAL TRANSMISSION APPARATUS, AND OPTICAL COMMUNICATION SYSTEM

(71) Applicant: NITTO DENKO CORPORATION, Osaka (JP)

(72) Inventors: Takeshi TANAKA, Osaka (JP); Yuichi TSUJITA, Osaka (JP)

(73) Assignee: NITTO DENKO CORPORATION, Osaka (JP)

(21) Appl. No.: 18/390,980

(22) Filed: Dec. 20, 2023

(30) Foreign Application Priority Data
Dec. 26, 2022 (JP) 2022-209077

(51) Int. Cl. H04B 10/50; H04B 10/2575

(52) U.S. Cl. CPC H04B 10/503; H04B 10/25759

(57) ABSTRACT

An optical transmitter includes a TOSA and an LC parallel circuit. The TOSA is configured to convert a first electrical signal into an optical signal. The LC parallel circuit includes an inductor and a capacitor. The inductor and the capacitor are connected in parallel to each other. The LC parallel circuit is connected to the TOSA.

### BACKGROUND OF THE INVENTION

### 1. Field of the Invention

The present invention relates to an optical transmitter, an optical transmitter array, an optical transmission apparatus, and an optical communication system.

### 2. Description of Related Art

Optical transmitters for converting electrical signals into optical signals are known. Examples of optical transmitters are described in, for example, JP 2015-216517 A and JP 2007-53672 A. A specific example of optical transmitters is one including a transmitter optical sub-assembly (TOSA).

### SUMMARY OF THE INVENTION

The present invention provides a technique suitable for enhancing the quality of signal transmission.

The present invention provides an optical transmitter including:
a TOSA configured to convert a first electrical signal into an optical signal; and
an LC parallel circuit including an inductor and a capacitor connected in parallel to each other, the LC parallel circuit being connected to the TOSA.

The present invention is suitable for enhancing the quality of signal transmission.

### BRIEF DESCRIPTION OF THE DRAWINGS

FIG. 1 is a configuration diagram of an optical communication system according to Embodiment 1.

FIG. 2A is a circuit diagram of a first bias tee and an optical transmitter.

FIG. 2B is an illustrative diagram of a parasitic component and an internal resistance.

FIG. 3A is a perspective view illustrating an analog configuration example in which a TOSA and an LC parallel circuit are included.

FIG. 3B is a plan view illustrating the analog configuration example in which the TOSA and the LC parallel circuit are included.

FIG. 4A is a perspective view illustrating a different analog configuration example in which the TOSA and the LC parallel circuit are included.

FIG. 4B is a plan view illustrating the different analog configuration example in which the TOSA and the LC parallel circuit are included.

FIG. 5A is a circuit diagram of a second bias tee and an optical receiver.

FIG. 5B is an illustrative diagram of a parasitic component.

FIG. 6A is a perspective view illustrating an analog configuration example in which a ROSA is included.

FIG. 6B is a plan view illustrating the analog configuration example in which the ROSA is included.

FIG. 7A is a perspective view illustrating a different analog configuration example in which the ROSA is included.

FIG. 7B is a plan view illustrating the different analog configuration example in which the ROSA is included.

FIG. 8 is a frequency spectrum diagram of an electrical signal for illustrating CNR.

FIG. 9 is an illustrative diagram of variation over time of the CNR of a second electrical signal.

FIG. 10 is a configuration diagram of an optical communication system according to Embodiment 2.

FIG. 11 is an illustrative diagram of a CWCN evaluation system.

FIG. 12 is an illustrative diagram of a comparative evaluation system.

FIG. 13 illustrates variation over time of the CNR of the second electrical signal for the use of Sample A.

FIG. 14 illustrates variation over time of the CNR of the second electrical signal for the use of Sample A.

FIG. 15 illustrates variation over time of the CNR of the second electrical signal for the use of Sample B.

FIG. 16 is an illustrative diagram of the position of the LC parallel circuit in a first modified evaluation system.

FIG. 17 is an illustrative diagram of the position of the LC parallel circuit in a second modified evaluation system.

FIG. 18 is an illustrative diagram of an LC parallel circuit in a third modified evaluation system.

### DETAILED DESCRIPTION OF THE INVENTION

Embodiments of the present invention will be described below with reference to the accompanying drawings. The following is only exemplary and not intended to limit the present invention.

### Embodiment 1

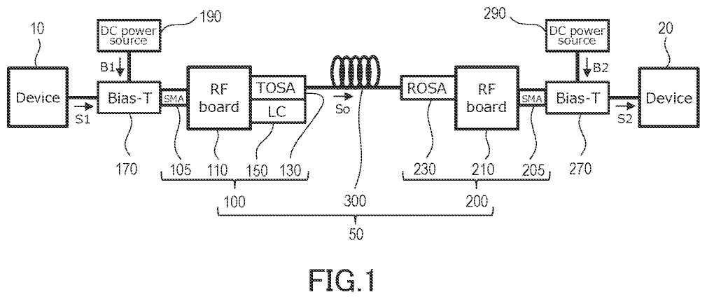

FIG. 1 is a configuration diagram of an optical communication system 50 according to Embodiment 1.

The optical communication system 50 includes an optical transmitter 100, an optical receiver 200, and an optical cable 300. The optical communication system 50 can be associated with a first device 10, a first direct current (DC) power source 190, a first bias tee 170, a second DC power source 290, a second bias tee 270, and a second device 20.

A first direct current bias B1 is fed from the first DC power source 190 to the optical transmitter 100 via the first bias tee 170. In this example, the first direct current bias B1 is a forward bias and a constant current. A second direct current bias B2 is fed from the second DC power source 290 to the optical receiver 200 via the second bias tee 270. In this example, the second direct current bias B2 is a reverse bias and a constant voltage. A first electrical signal S1 is fed from the first device 10 to the optical transmitter 100 via the first bias tee 170. In the optical transmitter 100, the first electrical signal S1 is converted into an optical signal So. The optical signal So is input from the optical transmitter 100 to the optical receiver 200 via the optical cable 300. In the optical receiver 200, the optical signal So is converted into a second electrical signal S2. The second electrical signal S2 is fed from the optical receiver 200 to the second device 20 via the second bias tee 270.

The components will be described below in detail.

### [Transmission Side Components]

The first device 10 outputs the first electrical signal S1. The first device 10 includes a signal source that generates the first electrical signal S1.

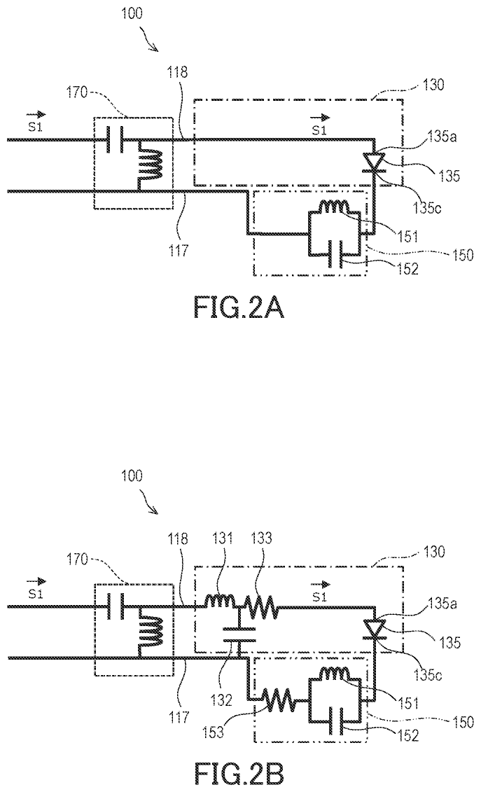

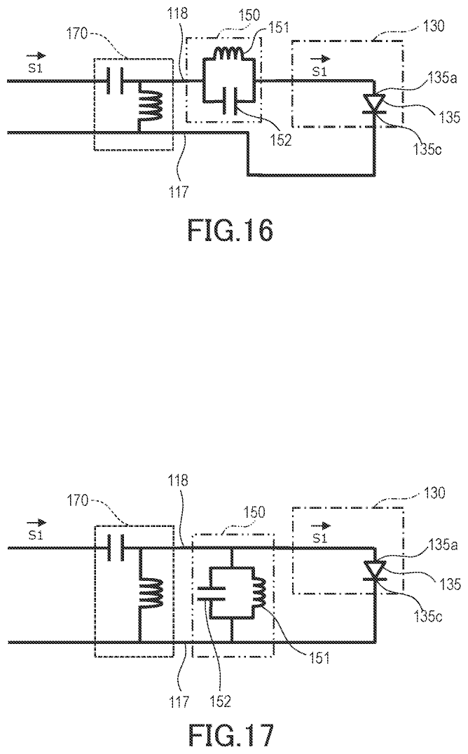

FIG. 2A is a circuit diagram of the first bias tee 170 and the optical transmitter 100. In FIG. 2A, a connector 105, a board (substrate) 110, a parasitic resistance, an internal resistance, and so on are not illustrated. The same applies to FIGS. 16 and 17.

As illustrated in FIG. 2A, the optical transmitter 100 includes a TOSA 130 and an LC parallel circuit 150. The TOSA 130 and the LC parallel circuit 150 are connected in series.

The first bias tee 170 can be connected to a first signal line 118 and a first ground 117. The first signal line 118, the TOSA 130, the LC parallel circuit 150, and the first ground 117 are connected in this order. The first signal line 118 can be set at a high electric potential relative to the first ground 117. Moreover, an input port 105i, the TOSA 130, the LC parallel circuit 150, and the first ground 117 are connected in this order. The input port 105i is an input portion for the first electrical signal S1 in the optical transmitter 100. Specifically, the input port 105i belongs to the connector 105 as will be described later.

The TOSA 130 includes a light-emitting device 135. The light-emitting device 135 includes an anode 135a and a cathode 135c. In Embodiment 1, the light-emitting device 135 is a semiconductor laser. The light-emitting device 135 is electrically connected to the LC parallel circuit 150. This semiconductor laser is specifically a laser diode (LD), more specifically a vertical cavity surface emitting laser (VCSEL). Another example of the light-emitting device 135 is a light-emitting diode (LED) or the like.

The LC parallel circuit 150 includes an inductor 151 and a capacitor 152. The inductor 151 and the capacitor 152 are connected in parallel to each other. The inductor 151 and the capacitor 152 are electrically connected to the light-emitting device 135. The inductor 151 and the capacitor 152 are electrically connected to the first ground 117.

The first bias tee 170 cooperates with the first DC power source 190 to set the first signal line 118 at a high electric potential relative to the first ground 117. Consequently, the anode 135a is set at a high electric potential relative to the cathode 135c.

The TOSA 130 converts the first electrical signal S1 into the optical signal So. Specifically, the light-emitting device 135 outputs the optical signal So in accordance with the first electrical signal S1 input to the light-emitting device 135.

To be exact, the TOSA 130 can have a parasitic component. The inductor 151 and the capacitor 152 each can have an internal resistance. FIG. 2B is an illustrative diagram of the parasitic component and the internal resistance. In FIG. 2B, a parasitic inductor 131, a parasitic capacitor 132, and a parasitic resistance 133 included in the TOSA 130 are schematically illustrated. Moreover, the internal resistance of the inductor 151 and the internal resistance of the capacitor 152 are schematically illustrated collectively as an internal resistance 153.

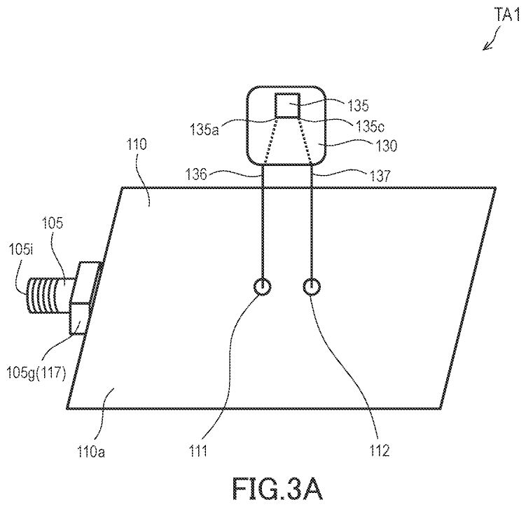

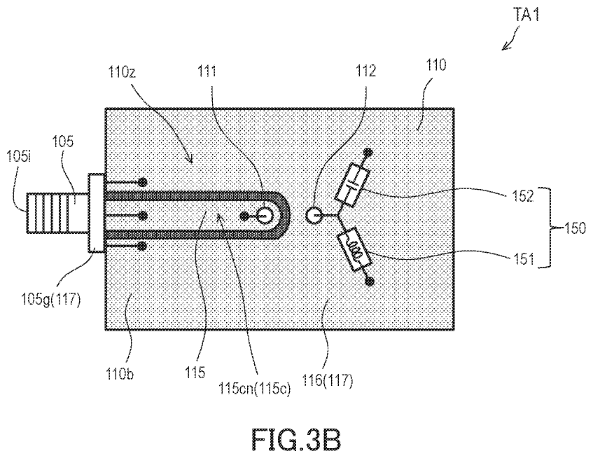

FIG. 3A is a perspective view illustrating Analog configuration example TA1 in which the TOSA 130 and the LC parallel circuit 150 are included. FIG. 3B is a plan view illustrating Analog configuration example TA1 in which the TOSA 130 and the LC parallel circuit 150 are included. Analog configuration example TA1 will be described below.

In Analog configuration example TA1, the optical transmitter 100 includes the board 110 and the connector 105. The connector 105 is fixed to the board 110. The board 110 has a front surface 110a, a back surface 110b, a hole 111, and a hole 112. The board 110 is specifically a radio frequency (RF) board.

On the back surface 110b, the LC parallel circuit 150, a conductive line 115, and a conductive plane 116 are provided. The conductive line 115 and the conductive plane 116 constitute a coplanar waveguide 115c. The coplanar waveguide 115c allows propagation of the first electrical signal S1. The conductive line 115 and the conductive plane 116 specifically constitute an ungrounded coplanar waveguide 115cn. The conductive plane 116 is included in the first ground 117.

The front surface 110a is positioned between the back surface 110b and the light-emitting device 135. Specifically, the front surface 110a is positioned so as to intersect with a virtual line segment connecting the back surface 110b and the light-emitting device 135.

The hole 111 and the hole 112 each extend through the board 110 from the front surface 110a to the back surface 110b. The conductive line 115 and the TOSA 130 are electrically connected to each other via the hole 111. The TOSA 130 and the LC parallel circuit 150 are electrically connected to each other via the hole 112. The LC parallel circuit 150 is connected to the conductive plane 116.

The TOSA 130 includes a lead 136 and a lead 137. The lead 136 is electrically connected to the conductive line 115 through the hole 111. The lead 137 is electrically connected to the LC parallel circuit 150 through the hole 112. Specifically, the lead 137 is electrically connected to the inductor 151 and the capacitor 152.

The connector 105 includes the input port 105i and a ground region 105g. The input port 105i is electrically connected to the conductive line 115. The first electrical signal S1 is input to the input port 105i. The ground region 105g is included in the first ground 117. Typically, the ground region 105g and the conductive plane 116 are electrically connected to each other by soldering. In the illustrated example, the connector 105 is a sub miniature type A (SMA) connector.

The first bias tee 170 can be connected to the input port 105i. The first bias tee 170, the input port 105i, the conductive line 115, the lead 136, the anode 135a, the cathode 135c, the lead 137, the LC parallel circuit 150, the conductive plane 116, and the ground region 105g can be connected in this order.

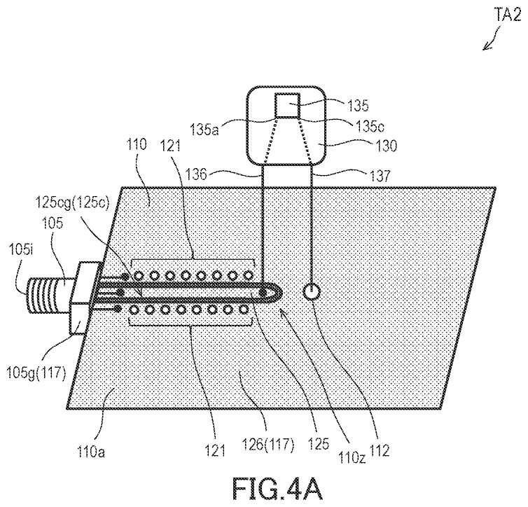

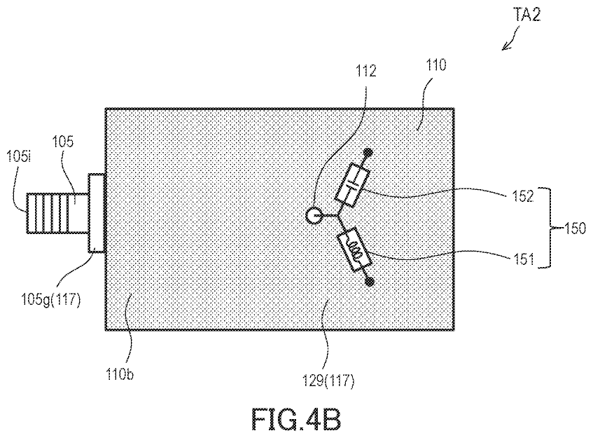

FIG. 4A is a perspective view illustrating Analog configuration example TA2 in which the TOSA 130 and the LC parallel circuit 150 are included. FIG. 4B is a plan view illustrating Analog configuration example TA2 in which the TOSA 130 and the LC parallel circuit 150 are included. Analog configuration example TA2 will be described below. In the following, the same components of Analog configuration example TA2 as the components of Analog configuration example TA1 are denoted by the same reference numerals, and their description may be omitted. The descriptions of Analog configuration example TA1 and Analog configuration example TA2 can be applied to each other unless they are technically contradictory to each other. Analog configuration example TA1 and Analog configuration example TA2 may be combined with each other unless they are technically contradictory to each other.

In Analog configuration example TA2, on the front surface 110a of the board 110, a conductive line 125 and a conductive plane 126 are provided. On the back surface 110b of the board 110, the LC parallel circuit 150 and a solid ground 129 are provided. The conductive plane 126 and the solid ground 129 are included in the first ground 117. The LC parallel circuit 150 is connected to the solid ground 129. Typically, the ground region 105g and the solid ground 129 are electrically connected to each other by soldering.

The conductive line 125 and the conductive plane 126 constitute a coplanar waveguide 125c. The coplanar waveguide 125c allows propagation of the first electrical signal S1. Specifically, the board 110 has a plurality of through holes 121. The plurality of through holes 121 each extend through the board 110 from the front surface 110a to the back surface 110b. Moreover, the plurality of through holes 121 are each provided with a conductive layer. The conductive layer electrically connects the conductive plane 126 and the solid ground 129 to each other. The conductive layer is typically a plating layer. The conductive line 125, the conductive plane 126, and the solid ground 129 constitute a grounded coplanar waveguide 125cg. In the present specification, the solid ground refers to a ground having a film shape.

On the front surface 110a side as viewed from the back surface 110b, the conductive line 125 and the TOSA 130 are connected to each other. The lead 136 of the TOSA 130 is electrically connected to the conductive line 125.

The first bias tee 170, the input port 105i, the conductive line 125, the lead 136, the anode 135a, the cathode 135c, the lead 137, the LC parallel circuit 150, the solid ground 129, and the ground region 105g can be connected in this order.

As is understood from the above description, in Analog configuration example TA1 and Analog configuration example TA2, the board 110 includes a first transmission path and a first ground pattern. The first transmission path allows propagation of the first electrical signal S1 toward the TOSA 130. The LC parallel circuit 150 is electrically connected to the first ground pattern.

Specifically, the board 110 includes an RF circuit 110z. The RF circuit 110z includes the first transmission path.

The first ground pattern refers to one or more grounds included in the board 110. In Analog configuration example TA1, the first ground pattern includes the conductive plane 116. In Analog configuration example TA2, the first ground pattern includes the conductive plane 126 and the solid ground 129.

The first transmission path has an impedance of, for example, 25Ω or more and 125Ω or less. The first transmission path includes, for example, at least one selected from the group consisting of a microstripline, a stripline, and a coplanar waveguide. In Analog configuration example TA1 and Analog configuration example TA2, the first transmission path is a coplanar waveguide. Specifically, in Analog configuration example TA1, the coplanar waveguide is an ungrounded coplanar waveguide. In Analog configuration example TA2, the coplanar waveguide is a grounded coplanar waveguide.

Here, the grounded coplanar waveguide refers to a waveguide that satisfies the following requirements:
on one of the front surface and the back surface of the board, a combination of a conductive line and a conductive plane is provided; and
in an overlapping region overlapping with the above combination on the other of the front surface and the back surface of the board in plan view of the board, a solid ground is provided.

In contrast, the ungrounded coplanar waveguide refers to a waveguide that satisfies the following requirements:
on one of the front surface and the back surface of the board, the above combination is provided; and
in the above overlapping region on the other of the front surface and the back surface of the board, a solid ground is not provided.

Moreover, the microstripline refers to a transmission line that satisfies the following requirements:
on one of the front surface and the back surface of the board, a conductive line is provided; and
in an overlapping region overlapping with the conductive line on the other of the front surface and the back surface of the board in plan view of the board, a solid ground is provided.

The ungrounded coplanar waveguide has the advantage of being suitable for surface mounting of chips and the advantage of requiring no process for providing through holes. The grounded coplanar waveguide has the advantage of being less prone to an influence of noise. The microstripline has the advantage of being easy to perform dimensional design.

### [Optical Cable]

The optical cable 300 is used for directing the optical signal So from the optical transmitter 100 to the optical receiver 200. In Embodiment 1, the optical cable 300 is an optical fiber, specifically, a plastic optical fiber (POF).

### [Reception Side Components]

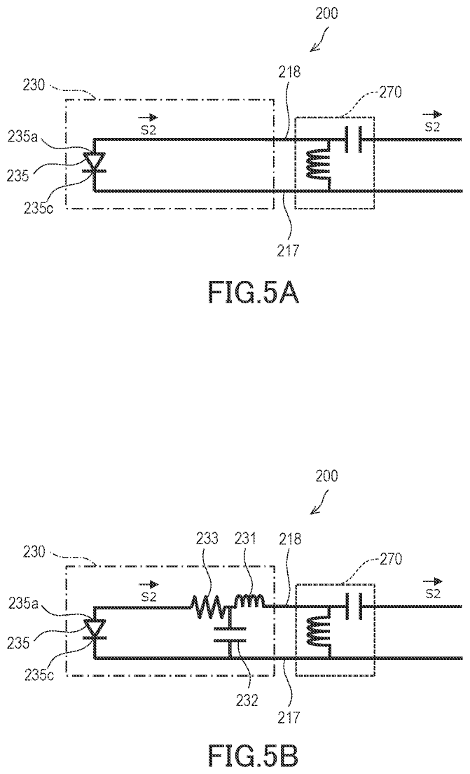

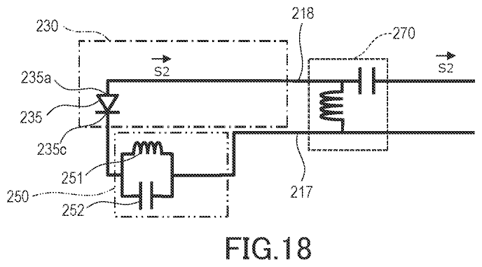

FIG. 5A is a circuit diagram of the second bias tee 270 and the optical receiver 200. In FIG. 5A, a parasitic resistance, an internal resistance, and so on are not illustrated. The same applies to FIG. 18.

As illustrated in FIG. 5A, the optical receiver 200 includes a receiver optical sub-assembly (ROSA) 230.

The second bias tee 270 can be connected to a second signal line 218 and a second ground 217. The second signal line 218, the ROSA 230, and the second ground 217 are connected in this order. The second signal line 218 can be set at a constant electric potential relative to the second ground 217. Moreover, an output port 2050, the ROSA 230, and the second ground 217 are connected in this order. The output port 2050 is an output portion for the second electrical signal S2 in the optical receiver 200. Specifically, the output port 2050 belongs to a connector 205 as will be described later.

The ROSA 230 includes a photodetector 235. The photodetector 235 includes an anode 235a and a cathode 235c. In Embodiment 1, the photodetector 235 is a photodiode. The photodiode is, for example, a PN photodiode or an avalanche photodiode.

The second bias tee 270 cooperates with the second DC power source 290 to set the second signal line 218 at a constant electric potential relative to the second ground 217. Consequently, the anode 235a is set at a constant electric potential relative to the cathode 235c.

In the optical receiver 200, the optical signal So is input to the ROSA 230. The ROSA 230 converts the optical signal So into the second electrical signal S2. Specifically, the photodetector 235 outputs the second electrical signal S2 in accordance with the optical signal So input to the photodetector 235.

To be exact, the ROSA 230 can have a parasitic component. FIG. 5B is an illustrative diagram of the parasitic component. In FIG. 5B, a parasitic inductor 231, a parasitic capacitor 232, and a parasitic resistance 233 included in the ROSA 230 are schematically illustrated.

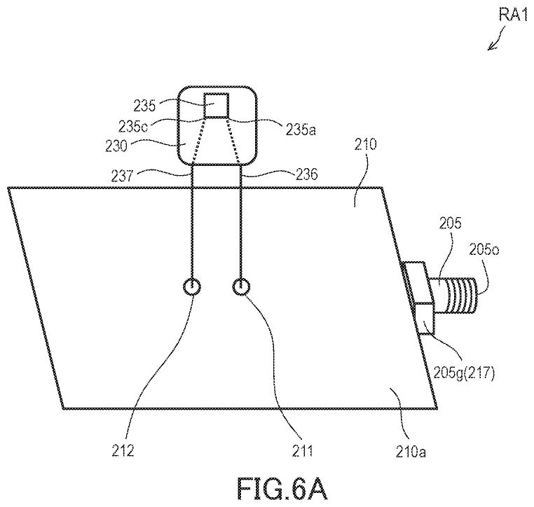

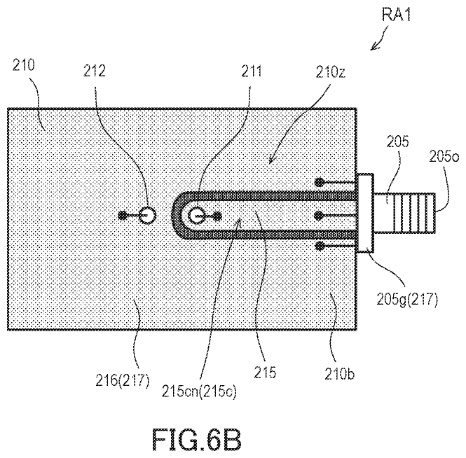

FIG. 6A is a perspective view illustrating Analog configuration example RA1 in which the ROSA 230 is included. FIG. 6B is a plan view illustrating Analog configuration example RA1 in which the ROSA 230 is included. Analog configuration example RA1 will be described below.

In Analog configuration example RA1, the optical receiver 200 includes a board (substrate) 210 and the connector 205. The connector 205 is fixed to the board 210. The board 210 has a front surface 210a, a back surface 210b, a hole 211, and a hole 212. The board 210 is specifically an RF board.

On the back surface 210b, a conductive line 215 and a conductive plane 216 are provided. The conductive line 215 and the conductive plane 216 constitute a coplanar waveguide 215c. The coplanar waveguide 215c allows propagation of the second electrical signal S2. Specifically, the conductive line 215 and the conductive plane 216 constitute an ungrounded coplanar waveguide 215cn. The conductive plane 216 is included in the second ground 217.

The front surface 210a is positioned between the back surface 210b and the photodetector 235. Specifically, the front surface 210a is positioned so as to intersect with a virtual line segment connecting the back surface 210b and the photodetector 235.

The hole 211 and the hole 212 each extend through the board 210 from the front surface 210a to the back surface 210b. The conductive line 215 and the ROSA 230 are electrically connected to each other via the hole 211. The ROSA 230 and the conductive plane 216 are electrically connected to each other via the hole 212.

The ROSA 230 includes a lead 236 and a lead 237. The lead 236 is electrically connected to the conductive line 215 through the hole 211. The lead 237 is electrically connected to the conductive plane 216 through the hole 212.

The connector 205 includes the output port 2050 and a ground region 205g. The output port 2050 is electrically connected to the conductive line 215. The second electrical signal S2 is output from the output port 2050. The ground region 205g is included in the second ground 217. Typically, the ground region 205g and the conductive plane 216 are electrically connected to each other by soldering. In the illustrated example, the connector 205 is an SMA connector.

The second bias tee 270 can be connected to the output port 2050. The second bias tee 270, the output port 2050, the conductive line 215, the lead 236, the anode 235a, the cathode 235c, the lead 237, the conductive plane 216, and the ground region 205g can be connected in this order.

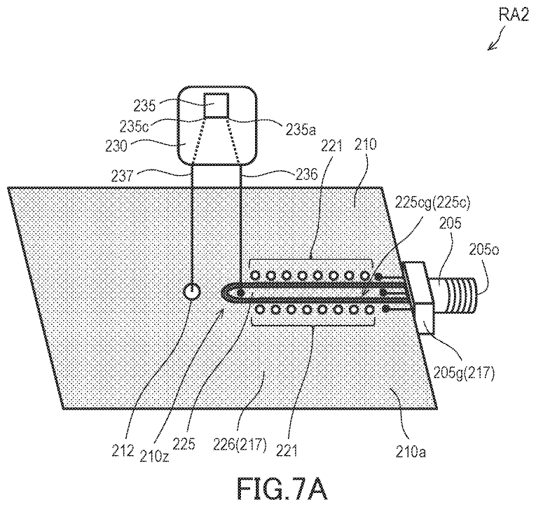

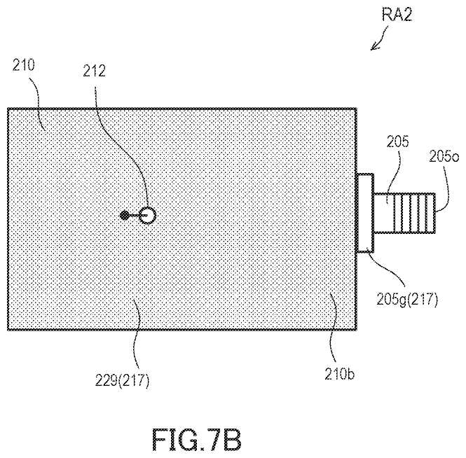

FIG. 7A is a perspective view illustrating Analog configuration example RA2 in which the ROSA 230 is included. FIG. 7B is a plan view illustrating Analog configuration example RA2 in which the ROSA 230 is included. Analog configuration example RA2 will be described below. In the following, the same components of Analog configuration example RA2 as the components of Analog configuration example RA1 are denoted by the same reference numerals, and their description may be omitted. The descriptions of Analog configuration example RA1 and Analog configuration example RA2 can be applied to each other unless they are technically contradictory to each other. Analog configuration example RA1 and Analog configuration example RA2 may be combined with each other unless they are technically contradictory to each other.

In Analog configuration example RA2, on the front surface 210a of the board 210, a conductive line 225 and a conductive plane 226 are provided. On the back surface 210b of the board 210, a solid ground 229 is provided. The conductive plane 226 and the solid ground 229 are included in the second ground 217. Typically, the ground region 205g and the solid ground 229 are electrically connected to each other by soldering.

The conductive line 225 and the conductive plane 226 constitute a coplanar waveguide 225c. The coplanar waveguide 225c allows propagation of the second electrical signal S2. Specifically, the board 210 includes a plurality of through holes 221. The plurality of through holes 221 each extend through the board 210 from the front surface 210a to the back surface 210b. Moreover, the plurality of through holes 221 are each provided with a conductive layer. The conductive layer electrically connects the conductive plane 226 and the solid ground 229 to each other. The conductive layer is typically a plating layer. The conductive line 225, the conductive plane 226, and the solid ground 229 constitute a grounded coplanar waveguide 225cg.

On the front surface 210a side as viewed from the back surface 210b, the conductive line 225 and the ROSA 230 are connected to each other. The lead 236 of the ROSA 230 is electrically connected to the conductive line 225.

The second bias tee 270, the output port 2050, the conductive line 225, the lead 236, the anode 235a, the cathode 235c, the lead 237, the solid ground 229, and the ground region 205g can be connected in this order.

As is understood from the above description, in Analog configuration example RA1 and Analog configuration example RA2, the board 210 includes a second transmission path and a second ground pattern. The second transmission path allows propagation of the second electrical signal S2 output from the ROSA 230.

Specifically, the board 210 includes an RF circuit 210z. The RF circuit 210z includes the second transmission path.

The second ground pattern refers to one or more grounds included in the board 210. In Analog configuration example RA1, the second ground pattern includes the conductive plane 216. In Analog configuration example RA2, the second ground pattern includes the conductive plane 226 and the solid ground 229.

The second transmission path has an impedance of, for example, 25Ω or more and 125Ω or less. The second transmission path includes, for example, at least one selected from the group consisting of a microstripline, a stripline, and a coplanar waveguide. In Analog configuration example RA1 and Analog configuration example RA2, the second transmission path is a coplanar waveguide. Specifically, in Analog configuration example RA1, the coplanar waveguide is an ungrounded coplanar waveguide. In Analog configuration example RA2, the coplanar waveguide is a grounded coplanar waveguide.

The second device 20 receives the second electrical signal S2. The second device 20 includes a receiver that receives the second electrical signal S2.

In Embodiment 1, the optical communication system 50 is for a cable television system. The first electrical signal S1 and the second electrical signal S2 are cable television signals. The first electrical signal S1 is typically a modulated signal, specifically a quadrature amplitude modulated (QAM) signal. Alternatively, the first electrical signal S1 may be an unmodulated continuous wave.

Here, the TOSA will be described. In the present specification, the TOSA is an assembly of a plurality of parts including a light-emitting device. The plurality of parts typically include a cap, an electrical interface, and an optical interface. The cap seals the light-emitting device so as to allow transmission of light emitted from the light-emitting device. The electrical interface is electrically connected to an electrical path through which an electrical signal propagates. The optical interface is optically connected to an optical path through which an optical signal propagates. The optical interface can be a light-transmissive portion, such as glass, provided in the cap.

In Embodiment 1, the TOSA 130 includes a cap that is not illustrated. The cap seals the light-emitting device 135 so as to allow transmission of light emitted from the light-emitting device 135. The lead 136 and the lead 137 constitute the electrical interface of the TOSA 130. The light-transmissive portion of the cap constitutes the optical interface of the TOSA 130. The light-emitting device 135 is optically connected to the optical cable 300 via the light-transmissive portion and an optical connector. The optical connector is, for example, a physical contact (PC) connector. The PC connector may be an angled physical contact (APC) connector. The optical connector and the optical cable 300 constitute an optical path.

Here, the ROSA will be described. In the present specification, the ROSA is an assembly of a plurality of parts including a photodetector. The plurality of parts typically include a cap, an electrical interface, and an optical interface. The cap seals the photodetector so as to allow transmission of light to the photodetector. The electrical interface is electrically connected to an electrical path through which an electrical signal propagates. The optical interface is optically connected to an optical path through which an optical signal propagates. The optical interface can be a light-transmissive portion, such as glass, provided in the cap.

In Embodiment 1, the ROSA 230 includes a cap that is not illustrated. The cap seals the photodetector 235 so as to allow transmission of light to the photodetector 235. The lead 236 and the lead 237 constitute the electrical interface of the ROSA 230. The light-transmissive portion of the cap constitutes the optical interface of the ROSA 230. The photodetector 235 is optically connected to the optical cable 300 via the light-transmissive portion and an optical connector. The optical connector is, for example, a PC connector. The PC connector may be an APC connector. The optical connector and the optical cable 300 constitute an optical path. [Effects, etc.]

Embodiment 1 is suitable for enhancing the quality of signal transmission. Specifically, Embodiment 1 is suitable for improving the carrier to noise ratio (CNR) of the second electrical signal S2. This point will be described below.

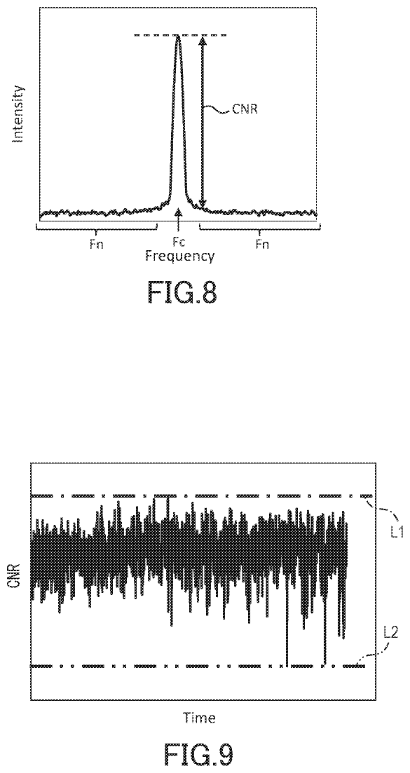

FIG. 8 is a frequency spectrum diagram of an electrical signal for illustrating CNR. The horizontal axis represents frequency. The vertical axis represents the intensity of each of the frequency components of the electrical signal. In FIG. 8, the carrier frequency of the electrical signal is indicated by sign Fc. The noise frequency of the electrical signal is indicated by sign Fn. CNR is the ratio of the intensity of the carrier frequency Fc component of the electrical signal to the intensity of the noise frequency Fn component of the electrical signal.

FIG. 9 is an illustrative diagram of variation over time of the CNR of the second electrical signal S2. The horizontal axis represents time. The vertical axis represents the CNR of the second electrical signal S2. In FIG. 9, the maximum value of the CNR of the second electrical signal S2 is indicated by a dashed dotted line L1. The minimum value of the CNR of the second electrical signal S2 is indicated by a dashed double-dotted line L2. The CNR of the second electrical signal S2 can vary over time.

“Improving the CNR of the second electrical signal S2” can encompass increasing the minimum value of the CNR of the second electrical signal S2. Moreover, “improving the CNR of the second electrical signal S2” can encompass suppressing variation over time of the CNR of the second electrical signal S2. Both increasing the above minimum value and suppressing the above variation over time can contribute to an enhancement in the quality of signal transmission.

In Embodiment 1, the LC parallel circuit 150 is connected to the TOSA 130. The LC parallel circuit 150 includes the inductor 151 and the capacitor 152. The LC parallel circuit 150 can contribute to an improvement in the CNR of the second electrical signal S2.

On the other hand, the ROSA 230 is electrically connected to the second ground 217. The photodetector 235 is electrically connected to the second ground 217. This can contribute to an improvement in the CNR of the second electrical signal S2. The optical receiver 200 of Embodiment 1 does not include an LC parallel circuit in which a chip inductor and a chip capacitor are connected in parallel to each other. Specifically, the optical receiver 200 of Embodiment 1 does not include an LC parallel circuit in which an inductor and a capacitor are connected in parallel to each other.

In Embodiment 1, the inductor 151 has an inductance of 20 μH or more and 200 μH or less. The capacitor 152 has a capacitance of 0.47 μF or more and 94 μF or less. These numerical ranges are advantageous in terms of improving the CNR of the second electrical signal S2. Moreover, in the domain where the inductance of the inductor 151 and the capacitance of the capacitor 152 are high to such degrees, the effect of improving the CNR of the second electrical signal S2 tends to be stably exhibited.

Specifically, the inductor 151 may have an inductance of 50 μH or more and 100 μH or less. The capacitor 152 may have a capacitance of 4.7 μF or more and 47 μF or less. These numerical ranges are particularly advantageous in terms of improving the CNR of the second electrical signal S2.

In Embodiment 1, the inductor 151 is a chip inductor. Accordingly, the inductance of the inductor 151 tends to be stabilized. Consequently, the CNR of the second electrical signal S2 can be improved with high reliability.

In Embodiment 1, the capacitor 152 is a chip capacitor. Accordingly, the capacitance of the capacitor 152 tends to be stabilized. Consequently, the CNR of the second electrical signal S2 can be improved with high reliability.

The inductor 151 may be achieved by spirally extending the line of the RF circuit 110z or the RF circuit 210z. The capacitor 152 may be achieved by providing a gap in the line of the RF circuit 110z or the RF circuit 210z.

In mass production of the optical transmitter 100, a manufacturing variability can occur in the characteristics of the TOSA 130. Specifically, the manufacturing variability can occur in the characteristics of the light-emitting device 135. In view of this, at least one parameter of the LC parallel circuit 150 may be variable. In this case, it is possible to set a parameter according to the characteristics. This can contribute to an improvement in the CNR of the second electrical signal S2. The inductor 151 may be, for example, a variable inductor. Moreover, the capacitor 152 may be, for example, a variable capacitor.

In Embodiment 1, the frequency of the first electrical signal S1 includes, for example, at least a portion of a band from 10 MHz to 3.2 GHZ. The frequency of the second electrical signal S2 includes, for example, at least a portion of a band from 10 MHz to 3.2 GHZ. The drive frequency of the light-emitting device 135 includes, for example, at least a portion of a band from 10 MHz to 3.2 GHZ. In the present specification, the drive frequency of the light-emitting device 135 refers to the frequency of an electrical signal that can be converted into an optical signal by the light-emitting device 135.

In a specific example, the frequency of the first electrical signal S1 includes at least a portion of a band from 10 MHz to 1 GHz. The frequency of the second electrical signal S2 includes at least a portion of a band from 10 MHz to 1 GHz. The drive frequency of the light-emitting device 135 includes at least a portion of a band from 10 MHz to 1 GHz.

In Embodiment 1, the optical transmitter 100 includes at least one passive circuit. The at least one passive circuit includes the LC parallel circuit 150. The first electrical signal S1 is input to the input port 105i of the connector 105. The optical transmitter 100 converts the first electrical signal S1 input to the input port 105i of the connector 105 into the optical signal So only by the light-emitting device 135 and the at least one passive circuit. Consequently, in Embodiment 1, the CNR of the second electrical signal S2 can be improved without a complicated configuration for signal correction. In the present specification, the passive circuit refers to a circuit composed of only a resistor, an inductor, and a capacitor.

In Embodiment 1, the optical transmitter 100 converts the first electrical signal S1 input to the input port 105i of the connector 105 into the optical signal So without performing feedback control of the first electrical signal S1 and without performing feedback control of the optical signal So. Consequently, in Embodiment 1, it is possible to improve the CNR of the second electrical signal S2 with a simple configuration.

Embodiment 2 will be described below. In the following, the descriptions of the matters already provided in Embodiment 1 may be omitted. The descriptions of these embodiments can be applied to each other unless they are technically contradictory to each other. These embodiments may be combined with each other unless they are technically contradictory to each other.

### Embodiment 2

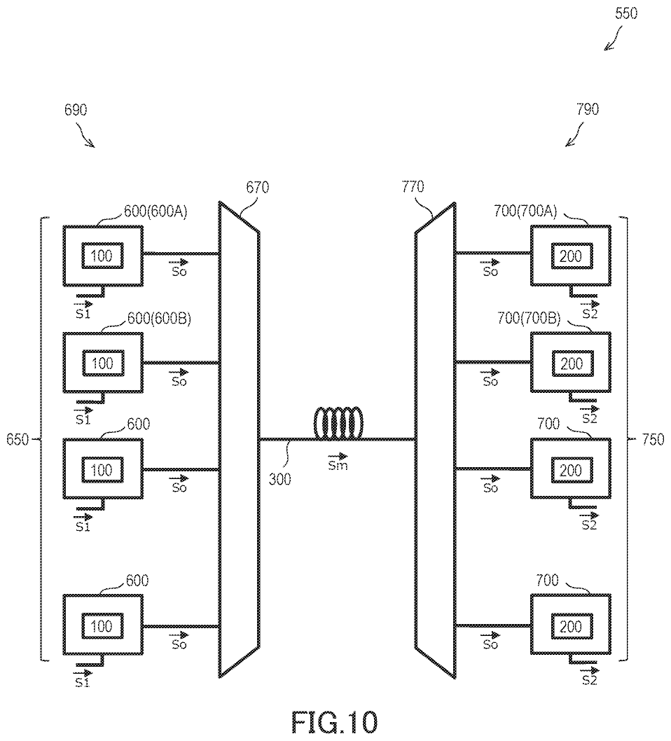

FIG. 10 is a configuration diagram of an optical communication system 550 according to Embodiment 2. In Embodiment 2, the optical communication system 550 is for a cable television system. In FIG. 10, a bias tee, a DC power source, and so on are not illustrated.

The optical communication system 550 includes an optical transmission apparatus 690, the optical cable 300, and an optical reception apparatus 790.

The optical transmission apparatus 690 includes an optical transmitter array 650 and a multiplexer 670. The optical transmitter array 650 includes a plurality of unit configurations 600. The plurality of unit configurations 600 each include the optical transmitter 100.

The optical reception apparatus 790 includes an optical receiver array 750 and a demultiplexer 770. The optical receiver array 750 includes a plurality of unit configurations 700. The plurality of unit configurations 700 each include the optical receiver 200.

In each of the plurality of unit configurations 600, the optical transmitter 100 converts the first electrical signal S1 into the optical signal So. The multiplexer 670 multiplexes the plurality of optical signals So. Thus, a multiplexed signal Sm is generated. Here, the common term “first electrical signal S1” is used for the optical transmitters 100 of the plurality of unit configurations 600. However, these first electrical signals S1 may not be identical signals. Likewise, the plurality of optical signals So may not be identical signals.

The optical cable 300 is used for directing the multiplexed signal Sm from the optical transmission apparatus 690 to the optical reception apparatus 790. Specifically, the optical cable 300 is used for directing the multiplexed signal Sm from the multiplexer 670 to the demultiplexer 770.

The demultiplexer 770 demultiplexes the multiplexed signal Sm into the plurality of optical signals So. The plurality of optical signals So are each input to a different one of the unit configurations 700. In each of the unit configurations 700, the optical receiver 200 converts the optical signal So into the second electrical signal S2. Here, the common term “second electrical signal S2” is used for the optical receivers 200 of the plurality of unit configurations 700. However, these second electrical signals S2 may not be identical signals. Likewise, the plurality of optical signals So may not be identical signals.

One of the plurality of unit configurations 600 is hereinafter referred to as a first unit configuration 600A. A different one of the plurality of unit configurations 600 is hereinafter referred to as a second unit configuration 600B. One of the plurality of unit configurations 700 is hereinafter referred to as a first unit configuration 700A. The different one of the plurality of unit configurations 700 is hereinafter referred to as a second unit configuration 700B. With use of these terms, Embodiment 2 can be described as follows.

The optical transmitter array 650 includes the first unit configuration 600A and the second unit configuration 600B. The multiplexer 670 generates the multiplexed signal Sm by multiplexing the plurality of optical signals So including the optical signal So fed from the first unit configuration 600A and the optical signal So fed from the second unit configuration 600B. The optical cable 300 is used for directing the multiplexed signal Sm from the optical transmission apparatus 690 to the optical reception apparatus 790. The demultiplexer 770 demultiplexes the multiplexed signal Sm into the plurality of optical signals So including the optical signal So that is to be fed to the first unit configuration 700A and the optical signal So that is to be fed to the second unit configuration 700B.

In mass production of the optical transmitter 100, a manufacturing variability can occur in the characteristics of the TOSA 130. Specifically, the manufacturing variability can occur in the characteristics of the light-emitting device 135. In view of this, a configuration may be adopted in which the value of at least one parameter of the LC parallel circuit 150 in one unit configuration 600 differs from the value of the parameter of the LC parallel circuit 150 in a different unit configuration 600. In this case, it is possible to set a parameter according to the characteristics of each of the unit configurations 600. This can contribute to an improvement in the CNR of the second electrical signal S2.

For example, the inductance of the inductor 151 of the first unit configuration 600A and the inductance of the inductor 151 of the second unit configuration 600B may differ from each other. The capacitance of the capacitor 152 of the first unit configuration 600A and the capacitance of the capacitor 152 of the second unit configuration 600B may differ from each other.

The inductances of the inductors 151 of the three or more unit configurations 600 may differ from each other. The capacitances of the capacitors 152 of the three or more unit configurations 600 may differ from each other.

### Experimental Example

The present invention will be described in detail with reference to an experimental example. The following experimental example is only illustrative of the present invention, and the present invention is not limited to the following experimental example.

### (CWCN Evaluation System)

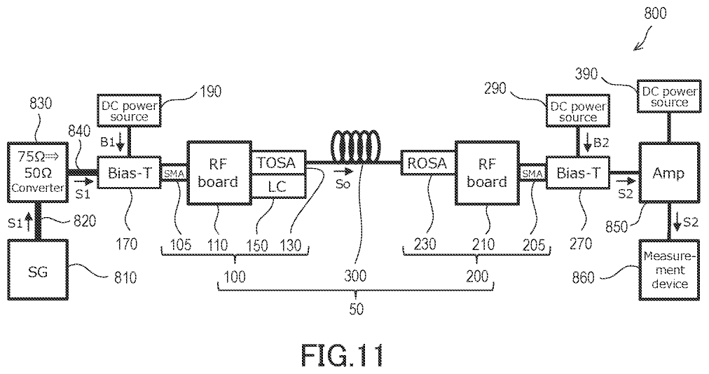

FIG. 11 is an illustrative diagram of a CWCN evaluation system 800. The CWCN evaluation system 800 includes a signal generator 810, a coaxial cable 820, an impedance converter 830, a coaxial cable 840, the first DC power source 190, the first bias tee 170, the optical communication system 50, the second DC power source 290, the second bias tee 270, a third DC power source 390, an amplifier 850, and a measurement device 860.

In the CWCN evaluation system 800, the optical communication system 50 was configured in accordance with Embodiment 1. In other words, the connector 105, the board 110, the TOSA 130, the LC parallel circuit 150, the optical cable 300, the ROSA 230, the board 210, and the connector 205 were connected in accordance with Embodiment 1. Adopted were Analog configuration example TA2 illustrated in FIGS. 4A and 4B and Analog configuration example RA2 illustrated in FIGS. 7A and 7B.

In the CWCN evaluation system 800, the first DC power source 190 was connected to the first bias tee 170. The signal generator 810, the coaxial cable 820, the impedance converter 830, the coaxial cable 840, and the first bias tee 170 were connected in this order. The first bias tee 170 was connected to the connector 105.

In the CWCN evaluation system 800, the connector 205 was connected to the second bias tee 270. The second DC power source 290 was connected to the second bias tee 270. The second bias tee 270, the amplifier 850, and the measurement device 860 were connected in this order. The third DC power source 390 was connected to the amplifier 850.

The signal generator 810 used was CLGD DOCSIS, multichannel signal generator, manufactured by Rohde & Schwarz GmbH & Co. KG.

The coaxial cable 820 used was UMA-ATC15 manufactured by Hanwha Q CELLS Japan Co., Ltd. This coaxial cable has a characteristic impedance of 75Ω.

The impedance converter 830 used was PD614 manufactured by Stack Electronics Co, Ltd. This impedance converter converts the characteristic impedance from 75Ω to 50Ω.

The coaxial cable 840 used was MWX221 manufactured by Junkosha Inc. This coaxial cable has a characteristic impedance of 50 Ω.

The first DC power source 190 used was 2400 manufactured by Keithley Instruments, Inc.

The first bias tee 170 used was BT0040 manufactured by Marki Microwave, Inc.

The connector 105 used was 526-5785 (RS Pro) manufactured by RS Components Ltd. This connector is an SMA connector.

The board 110 used was a dielectric board. This board has a relative permittivity of 4.2. The board has a thickness of 0.8 mm. The conductive line 125, the conductive plane 126, and the solid ground 129 are each formed of a copper foil. The board has dimensions of 40 mm long×40 mm wide as viewed in plan. The conductive line 125 has a length of 19 mm.

The TOSA 130 was self-produced. Specifically, the self-produced TOSA 130 includes the light-emitting device 135, a base, the lead 136, the lead 137, and a cap. The lead 136 and the lead 137 extend from the base. The cap has glass that allows transmission of light. The light-emitting device 135 used was a VCSEL. The light-emitting device 135 was mounted on the base by adhering the light-emitting device 135 to the base. The anode 135a of the light-emitting device 135 and the lead 136 were electrically connected to each other with a wire. The cathode 135c of the light-emitting device 135 and the lead 137 were electrically connected to each other with a wire. The light-emitting device 135 was sealed with the cap. Specifically, this sealing was performed so that the light-emitting surface of the light-emitting device 135 faced the glass of the cap. The light-emitting device 135 and the optical cable 300 were optically connected to each other with an optical connector.

The inductor 151 of the LC parallel circuit 150 used was a chip inductor. The capacitor 152 of the LC parallel circuit 150 used was a chip capacitor. The electrical connection of the chip inductor and the chip capacitor to the lead 137 and to the solid ground 129 was performed by soldering.

The optical cable 300 used was a POF having a length of 50 m. The connection between the optical cable 300 and the ROSA 230 was performed with an APC connector.

The ROSA 230 was self-produced. Specifically, the self-produced ROSA 230 includes the photodetector 235, a base, the lead 236, the lead 237, and a cap. The lead 236 and the lead 237 extend from the base. The cap has glass that allows transmission of light. The photodetector 235 used was a photodiode. The photodetector 235 was mounted on the base by adhering the photodetector 235 to the base. The anode 235a of the photodetector 235 and the lead 236 were electrically connected to each other with a wire. The cathode 235c of the photodetector 235 and the lead 237 were electrically connected to each other with a wire. The photodetector 235 was sealed with the cap. Specifically, this sealing was performed so that the light-emitting surface of the photodetector 235 faced the glass of the cap. The photodetector 235 and the optical cable 300 were optically connected to each other with an optical connector.

The board 210 used was a dielectric board. This board has a relative permittivity of 4.2. The board has a thickness of 0.8 mm. The conductive line 225, the conductive plane 226, and the solid ground 229 are each formed of a copper foil. The board has dimensions of 40 mm long×40 mm wide as viewed in plan. The conductive line 225 has a length of 19 mm.

The connector 205 used was 526-5785 (RS Pro) manufactured by RS Components Ltd. This connector is an SMA connector.

The second DC power source 290 used was KX210L manufactured by TAKASAGO, LTD.

The second bias tee 270 used was ZX85-12G-S+ manufactured by Mini-Circuits.

The amplifier 850 used was ZX60-6013E-S+ manufactured by Mini-Circuits.

The third DC power source 390 used was 6146 (ADCMT) manufactured by ADC CORPORATION.

The measurement device 860 used was N9010B manufactured by Agilent Technologies, Inc. This measurement device is a spectrum analyzer.

In each of the experiments of the experimental example, the signal generator 810 was set to output, as the first electrical signal S1, a signal having a frequency component of 99 MHz whose power ratio over the whole frequency range of the first electrical signal S1 is 2.2%, toward the first bias tee 170. This frequency component is the frequency component having the maximum power ratio in the first electrical signal S1.

In each of the experiments of the experimental example, the first DC power source 190 was set to output, as the first direct current bias B1, a forward bias that is a constant current of 8.8 mA toward the first bias tee 170. Thus, the first signal line 118 was set at a high electric potential relative to the first ground 117.

In each of the experiments of the experimental example, the second DC power source 290 was set to output, as the second direct current bias B2, a reverse bias that is a constant voltage of 5 V toward the second bias tee 270. Thus, the second signal line 218 was set at a constant electric potential relative to the second ground 217.

In each of the experiments of the experimental example, power was supplied from the third DC power source 390 to the amplifier 850. The second electrical signal S2 was amplified by the amplifier 850 and then input to the measurement device 860.

The measurement device 860 has a 50Ω terminating resistor. In each of the experiments of the experimental example, the voltage applied to the terminating resistor was measured with the measurement device 860. The voltage was converted into current. On the basis of the current, the continuous-wave carrier to noise (CWCN) of the second electrical signal S2 was determined. The determination of the CWCN was continuously performed for 30 minutes. Specifically, in an advance preparation, the signal generator 810 and the measurement device 860 were directly connected to each other. In this direct connection state, the setting value of the signal generator 810 was determined. The setting value defines the intensity of the first electrical signal S1 to be output from the signal generator 810. The setting value was determined so that the voltage of the 50Ω terminating resistor of the measurement device 860 was 80 dBμV. Thereafter, the CWCN evaluation system 800 illustrated in FIG. 11 was configured. Then, while the first electrical signal S1 was output from the signal generator 810 set to the setting value determined as above, the second electrical signal S2 was measured for 30 minutes.

As described above, the first electrical signal S1 can be a modulated signal, specifically a quadrature amplitude modulated signal. For example, in an actual cable television system, a modulated signal can be used as the first electrical signal S1. Then, as an evaluation indicator for the quality of signal transmission, the CNR of the second electrical signal S2 derived from the modulated signal can be used. On the other hand, in each of the experiments of the experimental example, the first electrical signal S1 is an unmodulated continuous wave. The CWCN determined on the basis of the above description is the CWCN of the second electrical signal S2 derived from the continuous wave. In the case where a favorable CWCN is exhibited in each of the experiments of the experimental example, a favorable CNR is expected to be exhibited in a system modified in which, instead of the first electrical signal S1 that is an unmodulated continuous wave, the first electrical signal S1 modulated is output from the signal generator 810. In the following description of each of the experiments of the experimental example, “CNR” strictly means “CWCN” unless any particular contradiction arises. For example, measuring the CWCN of the second electrical signal S2 continuously for 30 minutes is hereinafter referred to as measuring the CNR of the second electrical signal S2 continuously for 30 minutes.

### (A: Evaluation of CNR for Each of Combinations of Inductor 151 and Capacitor 152)

The plurality of LC parallel circuits 150 were prepared. These LC parallel circuits 150 differ from each other in terms of at least one selected from the group consisting of the inductor 151 and the capacitor 152. Specifically, the inductor 151 is a 20 μH, 50 μH, 100 μH, or 200 μH chip inductor. The capacitor 152 is a 0.47 μF, 4.7 μF, 47 μF, or 94 μF chip capacitor. The TOSA 130 produced was Sample A and Sample B. Sample A and Sample B were produced by using the same parts and the same assembly method. Sample A and Sample B do not have intentional non-identity (variation). Either Sample A or Sample B was used as the TOSA 130, and any of these LC parallel circuits 150 was connected to the TOSA 130. The CWCN evaluation system 800 was thus configured. The CNR of the second electrical signal S2 in each of the CWCN evaluation systems 800 configured was measured continuously for 30 minutes.

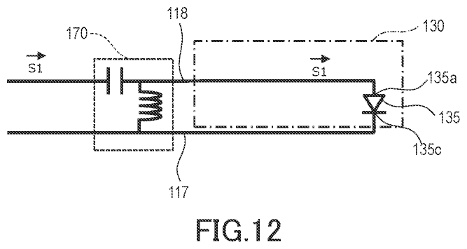

Moreover, the LC parallel circuit 150 was omitted from the CWCN evaluation system 800, either Sample A or Sample B was used as the TOSA 130, and the TOSA 130 and the solid ground 129 were electrically connected to each other. A comparative evaluation system was thus configured. FIG. 12 is an illustrative diagram of the comparative evaluation system. The CNR of the second electrical signal S2 in the comparative evaluation system configured was measured continuously for 30 minutes.

The minimum value of the CNR of the second electrical signal S2 in a 30-minute measurement is hereinafter referred to as CNRmin. The ratio of CNRmin in the CWCN evaluation system 800 to CNRmin in the comparative evaluation system was calculated. The improvement in CNRmin was thus evaluated. The evaluation results are shown in Table 1. In Table 1, the numerical values in the column “L [μH]” each indicate the inductance of the inductor 151. The numerical values in the column “C [μF]” each indicate the capacitance of the capacitor 152. The numerical values in the column “Sample A” each indicate the above ratio for the use of Sample A as the TOSA 130 (unit: dB). The numerical values in the column “Sample B” each indicate the above ratio for the use of Sample B as the TOSA 130 (unit: dB).

TABLE 1

| L [μH] | C [μF] | Sample A | Sample B |
|---|---|---|---|
| 0 | 0 | Reference | Reference |
| 20 | 0.47 | 1.14 | 0.53 |
| 20 | 4.7 | 0.30 | 2.65 |
| 20 | 47 | 0.88 | 1.36 |
| 20 | 94 | 0.07 | — |
| 50 | 0.47 | — | 0.62 |
| 50 | 4.7 | 1.66 | 2.91 |
| 50 | 47 | 1.18 | 0.30 |
| 50 | 94 | 3.12 | 0.32 |
| 100 | 0.47 | 0.88 | — |
| 100 | 4.7 | 0.81 | — |
| 100 | 47 | 0.91 | 1.66 |
| 100 | 94 | — | — |
| 200 | 0.47 | 1.13 | — |
| 200 | 4.7 | 1.24 | 0.83 |
| 200 | 47 | 0.36 | 0.42 |
| 200 | 94 | 0.04 | — |

The standard deviation (o) of the CNR of the second electrical signal S2 in the 30-minute measurement is hereinafter referred to as CNRσ. The ratio of CNRσ in the CWCN evaluation system 800 to CNRσ in the comparative evaluation system was calculated. CNRσ was thus evaluated. The evaluation results are shown in Table 2. In Table 2, the numerical values in the column “L [μH]” each indicate the inductance of the inductor 151. The numerical values in the column “C [μF]” each indicate the capacitance of the capacitor 152. The numerical values in the column “Sample A” each indicate the above ratio for the use of Sample A as the TOSA 130 (unit: dB). The numerical values in the column “Sample B” each indicate the above ratio for the use of Sample B as the TOSA 130 (unit: dB).

TABLE 2

| L [μH] | C [μF] | Sample A | Sample B |
|---|---|---|---|
| 0 | 0 | Reference | Reference |
| 20 | 0.47 | −0.73 | −0.09 |
| 20 | 4.7 | −1.19 | −0.49 |
| 20 | 47 | −1.06 | −0.37 |
| 20 | 94 | −1.13 | −0.06 |
| 50 | 0.47 | −0.92 | −0.35 |
| 50 | 4.7 | −2.11 | −0.59 |
| 50 | 47 | −0.72 | — |
| 50 | 94 | −1.85 | −0.50 |
| 100 | 0.47 | −1.05 | −0.02 |
| 100 | 4.7 | −1.00 | −0.05 |
| 100 | 47 | −0.82 | −0.50 |
| 100 | 94 | −0.66 | −0.17 |
| 200 | 0.47 | −0.77 | −0.13 |
| 200 | 4.7 | −0.78 | −0.16 |
| 200 | 47 | −0.53 | −0.45 |
| 200 | 94 | −1.03 | −0.03 |

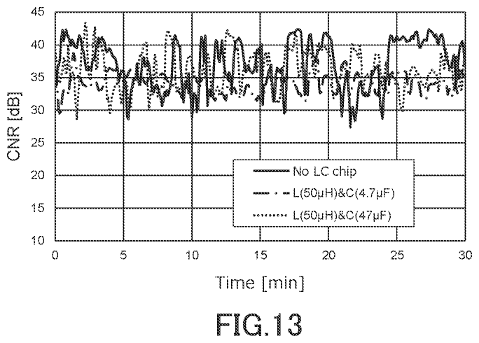

FIG. 13 illustrates variation over time of the CNR of the second electrical signal S2 for the use of Sample A. Specifically, FIG. 13 illustrates variation over time for a case “no LC chip”, variation over time for a case “L (50 μH) & C (4.7 μF)”, and variation over time for a case “L (50 μH) & C (47 μF)”. The variation over time for the case “no LC chip” indicates the variation over time in the comparative evaluation system. The variation over time for the case “L (50 μH) & C (4.7 μF)” indicates the variation over time for the case where the inductance of the inductor 151 is 50 μH and the capacitance of the capacitor 152 is 4.7 μF in the CWCN evaluation system 800. The variation over time for the case “L (50 μH) & C (47 μF)” indicates the variation over time for the case where the inductance of the inductor 151 is 50 μH and the capacitance of the capacitor 152 is 47 μF in the CWCN evaluation system 800.

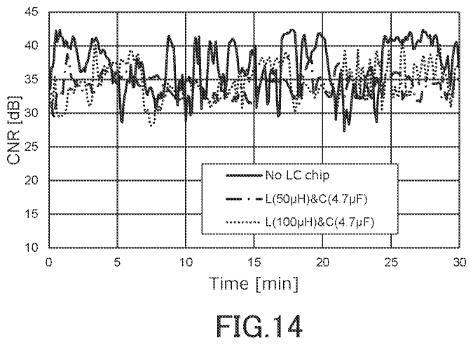

FIG. 14 illustrates variation over time of the CNR of the second electrical signal S2 for the use of Sample A. Specifically, FIG. 14 illustrates the variation over time for the case “no LC chip”, the variation over time for the case “L (50 μH) & C (4.7 μF)”, and variation over time for the case “L (100 μH) & C (4.7 μF)”. The variation over time for the case “no LC chip” indicates the variation over time in the comparative evaluation system. The variation over time for the case “L (50 μH) & C (4.7 μF)” indicates the variation over time for the case where the inductance of the inductor 151 is 50 μH and the capacitance of the capacitor 152 is 4.7 μF in the CWCN evaluation system 800. The variation over time for the case “L (100 μH) & C (4.7 μF)” indicates the variation over time for the case where the inductance of the inductor 151 is 100 μH and the capacitance of the capacitor 152 is 4.7 μF in the CWCN evaluation system 800.

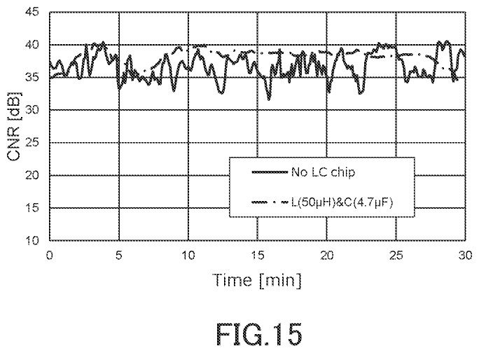

FIG. 15 illustrates variation over time of the CNR of the second electrical signal S2 for the use of Sample B. Specifically, FIG. 15 illustrates variation over time for the case “no LC chip” and variation over time for the case “L (50 μH) & C (4.7 μF)”. The variation over time for the case “no LC chip” indicates the variation over time for the comparative evaluation system. The variation over time for the case “L (50 μH) & C (4.7 μF)” indicates the variation over time for the case where the inductance of the inductor 151 is 50 μH and the capacitance of the capacitor 152 is 4.7 μF in the CWCN evaluation system 800.

As demonstrated in Tables 1 and 2 and FIGS. 13 to 15, the use of Sample A as the TOSA 130 and the use of Sample B as the TOSA 130 differ in evaluation results from each other. The difference is inferred to be derived from the manufacturing variability between the light-emitting device 135 of Sample A and the light-emitting device 135 of Sample B.

### (B1: Position Change of LC Parallel Circuit 150)

A first modified evaluation system was produced by changing the position of the LC parallel circuit 150 in the CWCN evaluation system 800. FIG. 16 is an illustrative diagram of the position of the LC parallel circuit 150 in the first modified evaluation system. In the first modified evaluation system, the first signal line 118, the LC parallel circuit 150, the TOSA 130, and the first ground 117 were connected in this order. The first signal line 118 was set at a high electric potential relative to the first ground 117. The improvement in CNRmin based on the LC parallel circuit 150 was smaller in the first modified evaluation system than in the CWCN evaluation system 800. Moreover, the improvement in CNRσ based on the LC parallel circuit 150 was smaller in the first modified evaluation system than in the CWCN evaluation system 800.

### (B2: Position Change of LC Parallel Circuit 150)

A second modified evaluation system was produced by changing the position of the LC parallel circuit 150 in the CWCN evaluation system 800. FIG. 17 is an illustrative diagram of the position of the LC parallel circuit 150 in the second modified evaluation system. In the second modified evaluation system, the LC parallel circuit 150 and the TOSA 130 were connected in parallel to each other between the first signal line 118 and the first ground 117. The first signal line 118 was set at a high electric potential relative to the first ground 117. The improvement in CNRmin based on the LC parallel circuit 150 was smaller in the second modified evaluation system than in the CWCN evaluation system 800. Moreover, the improvement in CNRσ based on the LC parallel circuit 150 was smaller in the second modified evaluation system than in the CWCN evaluation system 800.

### (C: Addition of LC Parallel Circuit to Reception Side)

A third modified evaluation system was produced by adding an LC parallel circuit 250 to the optical receiver 200 in the CWCN evaluation system 800. FIG. 18 is an illustrative diagram of the LC parallel circuit 250 in the third modified evaluation system. In the third modified evaluation system, the second signal line 218, the ROSA 230, the LC parallel circuit 250, and the second ground 217 are connected in this order. The LC parallel circuit 250 includes an inductor 251 and a capacitor 252. The inductor 251 and the capacitor 252 are connected in parallel to each other. The second signal line 218 is set at a constant electric potential relative to the second ground 217. The level of the second electrical signal S2 measured with the measurement device 860 was lower in the third modified evaluation system than in the CWCN evaluation system 800.

### (Supplementary Description)

The present disclosure discloses the following techniques.

### (Technique 1)

An optical transmitter comprising:
a TOSA configured to convert a first electrical signal into an optical signal; and
an LC parallel circuit including an inductor and a capacitor connected in parallel to each other, the LC parallel circuit being connected to the TOSA.

### (Technique 2)

The optical transmitter according to Technique 1, wherein
the inductor has an inductance of 20 μH or more and 200 μH or less, and
the capacitor has a capacitance of 0.47 μF or more and 94 μF or less.

### (Technique 3)

The optical transmitter according to Technique 2, wherein
the inductor has an inductance of 50 μH or more and 100 μH or less, and
the capacitor has a capacitance of 4.7 μF or more and 47 μF or less.

### (Technique 4)

The optical transmitter according to any one of Techniques 1 to 3, wherein
the TOSA and the LC parallel circuit are connected in series.

### (Technique 5)

The optical transmitter according to any one of Techniques 1 to 4, comprising:
a first ground; and
a first signal line, wherein
the first signal line, the TOSA, the LC parallel circuit, and the first ground are connected in this order.

### (Technique 6)

The optical transmitter according to any one of Techniques 1 to 5, comprising a first ground, wherein
the inductor and the capacitor are electrically connected to the first ground.

### (Technique 7)

The optical transmitter according to any one of Techniques 1 to 6, comprising a board, wherein
the board includes:
   a first transmission path that allows propagation of the first electrical signal toward the TOSA; and
   a first ground pattern to which the LC parallel circuit is electrically connected.

### (Technique 8)

The optical transmitter according to Technique 7, wherein
the board includes an RF circuit, and
the RF circuit includes the first transmission path.

### (Technique 9)

The optical transmitter according to Technique 7 or 8, wherein
the first transmission path includes at least one selected from the group consisting of a microstripline, a stripline, and a coplanar waveguide.

### (Technique 10)

The optical transmitter according to any one of Techniques 1 to 9, wherein
the TOSA includes a light-emitting device, and
the light-emitting device is configured to output the optical signal in accordance with the first electrical signal input to the light-emitting device.

### (Technique 11)

The optical transmitter according to Technique 10, wherein
the light-emitting device is a semiconductor laser.

### (Technique 12)

The optical transmitter according to Technique 10 or 11, wherein
the light-emitting device is electrically connected to the inductor and the capacitor.

### (Technique 13)

The optical transmitter according to any one of Techniques 10 to 12, wherein
a drive frequency of the light-emitting device includes at least a portion of a band from 10 MHz to 3.2 GHz.

### (Technique 14)

The optical transmitter according to any one of Techniques 10 to 13, comprising:
a connector having an input port to which the first electrical signal is to be input; and
at least one passive circuit including the LC parallel circuit, wherein
the optical transmitter is configured to convert the first electrical signal input to the input port into the optical signal only by the light-emitting device and the at least one passive circuit.

### (Technique 15)

The optical transmitter according to any one of Techniques 1 to 14, comprising
a connector having an input port to which the first electrical signal is to be input, wherein
the optical transmitter is configured to convert the first electrical signal input to the input port into the optical signal without performing feedback control of the first electrical signal and without performing feedback control of the optical signal.

### (Technique 16)

The optical transmitter according to any one of Techniques 1 to 15, wherein
at least one selected from the group consisting of the following (1) and (2) is satisfied:
(1) the inductor is a chip inductor; and
(2) the capacitor is a chip capacitor.

### (Technique 17)

The optical transmitter according to any one of Techniques 1 to 16, wherein
at least one selected from the group consisting of the following (i) and (ii) is satisfied:
(i) the inductor is a variable inductor; and
(ii) the capacitor is a variable capacitor.

### (Technique 18)

An optical communication system comprising:
the optical transmitter according to any one of Techniques 1 to 17;
an optical receiver; and
an optical cable used for directing the optical signal from the optical transmitter to the optical receiver.

### (Technique 19)

The optical communication system according to Technique 18, wherein
the optical receiver includes a photodetector and a second ground,
the photodetector is configured to output a second electrical signal in accordance with the optical signal input to the photodetector, and
the photodetector is electrically connected to the second ground.

### (Technique 20)

The optical communication system according to Technique 18 or 19, being for a cable television system.

### (Technique 21)

An optical transmitter array comprising:
a first unit configuration and a second unit configuration, wherein
the first unit configuration and the second unit configuration each include the optical transmitter according to any one of Techniques 1 to 17, and
at least one selected from the group consisting of the following (I) and (II) is satisfied:
(I) an inductance of the inductor of the first unit configuration and an inductance of the inductor of the second unit configuration differ from each other; and
(II) a capacitance of the capacitor of the first unit configuration and a capacitance of the capacitor of the second unit configuration differ from each other.

### (Technique 22)

An optical transmission apparatus comprising:
the optical transmitter array according to Technique 21; and
a multiplexer configured to generate a multiplexed signal by multiplexing a plurality of optical signals including the optical signal fed from the first unit configuration and the optical signal fed from the second unit configuration.

### (Technique 23)

An optical communication system comprising:
the optical transmission apparatus according to Technique 22;
an optical reception apparatus; and
an optical cable used for directing the multiplexed signal from the optical transmission apparatus to the optical reception apparatus, wherein
the optical reception apparatus includes a demultiplexer configured to demultiplex the multiplexed signal into the plurality of optical signals.

### INDUSTRIAL APPLICABILITY

The technique according to the present invention can be used for a cable television system and the like. Specifically, the technique according to the present invention can be used for video distribution of high resolution such as 8K resolution. The present invention is suitable for enhancing the quality of signal transmission. Specifically, according to the present invention, it is possible to improve the CNR of the signal in the receiving system that receives signals from transmitters. In a cable television system, the image quality can be enhanced by improving the CNR of the signal in the receiving system.

What is claimed is:

1. An optical transmitter comprising:
a TOSA configured to convert a first electrical signal into an optical signal; and
an LC parallel circuit including an inductor and a capacitor connected in parallel to each other, the LC parallel circuit being connected to the TOSA.

2. The optical transmitter according to claim 1, wherein
the inductor has an inductance of 20 μH or more and 200 μH or less, and
the capacitor has a capacitance of 0.47 μF or more and 94 μF or less.

3. The optical transmitter according to claim 2, wherein
the inductor has an inductance of 50 μH or more and 100 μH or less, and
the capacitor has a capacitance of 4.7 μF or more and 47 μF or less.

4. The optical transmitter according to claim 1, wherein
the TOSA and the LC parallel circuit are connected in series.

5. The optical transmitter according to claim 4, comprising:
a first ground; and
a first signal line, wherein
the first signal line, the TOSA, the LC parallel circuit, and the first ground are connected in this order.

6. The optical transmitter according to claim 1, comprising a first ground, wherein the inductor and the capacitor are electrically connected to the first ground.

7. The optical transmitter according to claim 1, comprising a board, wherein the board includes:
a first transmission path that allows propagation of the first electrical signal toward the TOSA; and
a first ground pattern to which the LC parallel circuit is electrically connected.

8. The optical transmitter according to claim 7, wherein
the board includes an RF circuit, and
the RF circuit includes the first transmission path.

9. The optical transmitter according to claim 7, wherein
the first transmission path includes at least one selected from the group consisting of a microstripline, a stripline, and a coplanar waveguide.

10. The optical transmitter according to claim 1, wherein
the TOSA includes a light-emitting device, and
the light-emitting device is configured to output the optical signal in accordance with the first electrical signal input to the light-emitting device.

11. The optical transmitter according to claim 10, wherein
the light-emitting device is a semiconductor laser.

12. The optical transmitter according to claim 10, wherein
the light-emitting device is electrically connected to the inductor and the capacitor.

13. The optical transmitter according to claim 10, wherein
a drive frequency of the light-emitting device includes at least a portion of a band from 10 MHz to 3.2 GHz.

14. The optical transmitter according to claim 10, comprising:
a connector having an input port to which the first electrical signal is to be input; and
at least one passive circuit including the LC parallel circuit, wherein
the optical transmitter is configured to convert the first electrical signal input to the input port into the optical signal only by the light-emitting device and the at least one passive circuit.

15. The optical transmitter according to claim 1, comprising
a connector having an input port to which the first electrical signal is to be input, wherein
the optical transmitter is configured to convert the first electrical signal input to the input port into the optical signal without performing feedback control of the first electrical signal and without performing feedback control of the optical signal.

16. The optical transmitter according to claim 1, wherein
at least one selected from the group consisting of the following (1) and (2) is satisfied:
(1) the inductor is a chip inductor; and
(2) the capacitor is a chip capacitor.

17. The optical transmitter according to claim 1, wherein
at least one selected from the group consisting of the following (i) and (ii) is satisfied:
(i) the inductor is a variable inductor; and
(ii) the capacitor is a variable capacitor.

18. An optical communication system comprising:
the optical transmitter according to claim 1;
an optical receiver; and
an optical cable used for directing the optical signal from the optical transmitter to the optical receiver.

19. The optical communication system according to claim 18, wherein
the optical receiver includes a photodetector and a second ground,
the photodetector is configured to output a second electrical signal in accordance with the optical signal input to the photodetector, and
the photodetector is electrically connected to the second ground.

20. The optical communication system according to claim 18, being for a cable television system.

21. An optical transmitter array comprising:
a first unit configuration and a second unit configuration, wherein
the first unit configuration and the second unit configuration each include the optical transmitter according to claim 1, and
at least one selected from the group consisting of the following (I) and (II) is satisfied:
(I) an inductance of the inductor of the first unit configuration and an inductance of the inductor of the second unit configuration differ from each other; and
(II) a capacitance of the capacitor of the first unit configuration and a capacitance of the capacitor of the second unit configuration differ from each other.

22. An optical transmission apparatus comprising:
the optical transmitter array according to claim 21; and
a multiplexer configured to generate a multiplexed signal by multiplexing a plurality of optical signals including the optical signal fed from the first unit configuration and the optical signal fed from the second unit configuration.

23. An optical communication system comprising:
the optical transmission apparatus according to claim 22;
an optical reception apparatus; and
an optical cable used for directing the multiplexed signal from the optical transmission apparatus to the optical reception apparatus, wherein
the optical reception apparatus includes a demultiplexer configured to demultiplex the multiplexed signal into the plurality of optical signals.
